(19) United States
(12) Patent Application Publication
(10) Pub. No.: US 2026/0153211 A1
(43) Pub. Date: Jun. 4, 2026

(54) Lighting Device, Rear-View Device and Motor Vehicle

(71) Applicant: Motherson Innovations Company Limited, London (GB)

(72) Inventors: Alf LIESENER, Bruchköbel (DE); Stefanie GÖTTLICHER, Bruchköbel (DE); Dominik ERNEWEIN, Bruchköbel (DE); Oliver SCHMIDT, Stuttgart (DE)

(21) Appl. No.: 19/123,113

(22) PCT Filed: Oct. 30, 2023
(86) PCT No.: PCT/EP2023/080196

§ 371 Date: Apr. 22, 2025

(30) Foreign Application Priority Data
Nov. 1, 2022 (DE) 10 2022 128 892.7

(51) Int. Cl. B60Q 1/26; F21S 41/148; F21S 41/24; F21S 43/14; F21S 43/241; F21Y 115/10

(52) U.S. Cl. CPC F21S 43/241; F21S 43/14; F21S 43/255; F21S 43/30; F21V 7/0008; F21W 2103/25

(57) ABSTRACT

The disclosure refers to a lighting device, which comprises at least one housing, at least one lens, and at least one light guide arranged at least in some areas between the housing and the lens, wherein light produced from at least one light source can be coupled into the light guide to be directed to the lens, wherein the light guide is formed together with a mask as a two component mould unit in a three dimensional shape adapted to a selected light pattern. It also refers to a rear-view device with such a lighting device as well as a motor vehicle with such a rear-view device.

### CROSS-REFERENCE TO RELATED APPLICATIONS

This application is a national-stage entry of International Patent Application No. PCT/EP2023/080196, filed on Oct. 30, 2023, which claims priority to German Patent Application No. DE 10 2022 128 892.7, filed on Nov. 1, 2022, each of which is incorporated herein by reference in its entirety.

### FIELD

The present disclosure relates to a lighting device for a rear-view device of a motor vehicle, a rear-view device with such a lighting device as well as a motor vehicle with such a rear-view device. The lighting device comprises at least one housing, at least one lens, at least one light source and at least one light guide arranged at least partly between the housing and the lens, wherein light emitted by the at least one light source is configured to be coupled into the light guide, to be directed to the at least one lens and to exist the at least one lens.

### BACKGROUND

Vehicles generally include rear-view devices mounted inside and outside the vehicle. The rear-view devices generally include one or more mirrors, cameras or any combination thereof for viewing a scenario at least around the rear-end of the vehicle and one or more lighting devices.

The term “vehicle” denotes any motor driven vehicle with or without trailers driven by a driver, where the driver requires information about people, other vehicles or objects in the (near) surrounding of the vehicle to be able to drive safety. As an example, vehicles are cars, trucks, tractors or trailers

The term “rear-view” is here defined as a view of the surrounding area of a vehicle, which is not in the field of view of a driver of the vehicle, i.e. the directions opposing, left, right, below and above of the viewing direction, but may also comprise the view in the direction of the viewing direction of the driver and/or any combinations of the directions.

The term “driver” and “driver of the vehicle” relates here to the person controlling the main parameters of the vehicle, such as for example direction, speed and/or altitude, e.g. normally the person located in the location specified for the controlling person, for example a seat, but may also relate to any other person or entity within or outside of the vehicle.

The term “light source” denotes a device from which light originates and is emitted. The light source may include one or more light emitting devices or solid-state light sources. The term “solid state” generally refers to light emitted by solid-state electroluminescence, as opposed to incandescent bulbs or fluorescent tubes. For example, the light source may include a semiconductor light emitting diode (LED) or laser diode, an OLED, polymer light emitting diode (PLED), an LED lamp package, LED chip or LED die, or an array of one or more of these devices. It should be understood that the light source may also include a color changing LED, that is the LED may be configured to change color when required.

The term “lightguide” denotes a light conducting element at least partly forming part of a housing, wherein the lightguide has a light receiving surface within an enclosure, which may be provided at least partly by the housing, and a light emitting surface outside the enclosure, such that light emitted from the light source is received by the light receiving surface of the lightguide and directed towards the light emitting surface of the lightguide, such that light is emitted from the lightguide. The lightguide may be made of transparent material. The light may be emitted from the lightguide with a uniform luminance throughout the light emitting surface.

The term “reflective element” denotes a reflective surface on which light, for example emitted from a lightguide, falls and gets reflected in a reflecting direction to emit a reflected light. The reflective element may be a polished or a coated surface providing a mirror-like surface finish.

Different functions and devices may be incorporated into and/or controlled with the help of a rear-view device. Of particular interest are functions and devices to enhance, extend and/or sustain the functionality of the rear-view device during normal or extreme conditions. The respective means may comprise heating and/or cooling means; cleaning means such as wipers, liquid and/or gaseous sprays; actuator means for moving the rear-view device or parts of it, such as for example a display, a camera system and/or parts of a camera system, comprising for example lenses, filters, light sources, adaptive optics like deformable mirrors, sensors and/or mirrors; and/or actuator means for inducing movement of other objects, for example parts of the vehicle and/or objects surrounding the vehicle. Furthermore, linear tracks and/or rotating wheels, like for example a filter wheel, for exchanging optical elements, comprising for example lenses, mirrors, light sources, sensors, adaptive optics like deformable mirrors and/or filters may be comprised.

Prominent examples for functions and devices incorporated into and/or controlled with the help of rear-view devices comprise lighting devices, for example in form of any kind of light module like an external light module, an internal light module, a front light, a back light, a fog light, a brake light, an acceleration light, a turn signal, a logo lamp, a puddle light, a flash light, a navigation light, a position light, an emergency light, a spotlight, a green light, a red light, a warning light, a turn signal light module, an approach light, a search light, an information light, a display and/or any combination thereof.

In recent years, lighting devices for vehicles have become important for their aesthetic appeal to consumers. Thus, vehicle manufacturers have made efforts to design vehicle lighting devices in consideration of the styling of the vehicle on which the lighting devices are mounted. Further, vehicle manufacturers may provide optional lighting effects (in addition to the legally required lighting functionality) to enhance vehicle styling.

It is difficult to provide aesthetically appealing vehicle lighting devices that meet the required technical specifications. For example, taillights on existing cars tend to be power hungry and need various components, such as reflectors. Head lamps are similar in that they require multiple components, such as reflectors, cut off devices and the like. Aesthetic lighting effects lead to an even greater number of components and complexity. Such vehicle lighting devices are not easily adapted to the styling of the vehicle.

Rear-view devices having lighting devices for providing a signal such as a turn signal, warning light, fog light etc. are commonly used in a vehicle. These lighting devices not only enhance or extend the functionality of the rear-view devices, but also provide aesthetic appeal to the vehicle. The lighting devices of the rear-view devices may include a light source such as a light emitting diode (LED) and a lightguide which gets illuminated to provide a signal outside the vehicle. These lighting devices may further be enhanced to emit a pattern of light, which not only provides lighting functionality to the vehicle but also provides aesthetic appeal and enhances styling of the vehicle.

A lighting device is known for example from U.S. Pat. No. 10,800,322 B2, wherein a light guide device on the one hand, and a housing device and/or a lens on the other hand, are at least in some areas connected to one another by means of overmolding at least in some areas of the light guide device.

U.S. Pat. No. 7,357,542 B2 refers to an external rear-view mirror for vehicles, comprising: a mirror head fixedly secured to the vehicle; a housing defining an opening and a housing rear wall, said housing rear wall defining a recess extending along a portion thereof; a turn-signal lamp for generating light, said turn-signal lamp fixedly secured to said housing rear wall and extending into said recess, said turn-signal lamp including a light lens covering said turn-signal lamp and defining an outside surface and an opening extending through said light lens; and an optical waveguide having a source portion end extending through said opening in said light lens for guiding the light generated by said turn-signal lamp outside said light lens and around said mirror head, said optical waveguide having a remaining portion fixedly secured to said outside surface of said light lens.

A rear-view mirror for a vehicle including a mirror head with a housing in which at least one light area is arranged including a turn light signal device with a light window and a turn light back plate and at least one color emitting light source in described in U.S. Pat. No. 7,850,350 B2. The light window is a fully transparent light guide for the color emitting light source, and the turn light signal device includes a separate color screen in front of a reflector visible through the light window positioned in a way the light of the light source is not passing directly though the color screen. The color screen may be structured in a defined design to fill at least a part of the lighting device

### SUMMARY

It is an object of the present disclosure to further develop the known lighting device for a rear-view device of a motor vehicle to improve the aesthetic impression.

This object is achieved by a lighting device which comprises at least one housing, at least one lens, at least one light source and at least one light guide arranged at least partly between the housing and the lens, wherein light emitted by the at least one light source is configured to be coupled into the at least one light guide, to be directed to the at least one lens and to exit the at least one lens, wherein the light guide is formed together with a mask as a two component mould unit in a three dimensional shape adapted to a selected light pattern.

Embodiments of the present disclosure may be defined in that the light guide formed together with the mask is formed with
i) at least one light guide projection extending towards the at least one lens, in particular tapering in the direction of the lens, and/or
ii) at least one recess, in particular within the region of the at least one light guide projection, and/or on the side facing away from the lens and/or the mask, and/or providing at least one light in-coupling regions, and/or
iii) at least one opening, in particular between two light guide projection, and/or on both sides of each light guide projection, and/or extending through the light guide, and/or
iv) optics in at least one light in-coupling region, light reflecting region and/or light out-coupling region not covered by the mask.

It may also be that the mask is formed with
i) at least one first mask part on at last one light guide projection,
ii) at least one second mask part between two light guide projection,
iii) third mask parts on both sides of one or more light guide projection, and/or
iv) at least one fourth mask part in the at last one opening, and/or
v) at least one fifth mask part having an end facing the lens, and/or
   the mask of the two component mould unit is facing the lens and/or extends at least partially parallel to the lens.

In further embodiments the at least one light source comprises one or more LEDs, comprises at least one colour changing light source, and/or cooperates with a colour changing element, and/or produces one or more light colours, and/or the light emitted by the at least one light source is redirected at least once by the two component mould unit and/or at least one reflector, and/or the at least one light source is screened by the mask and/or cannot be seen through the lens.

Still further, it may be that the two component mould unit is, in particular detachably attached to the at least one of the housing and/or the lens.

Embodiments of the present disclosure may be characterized in that the housing comprises an upper cover element and a lower cover element, with the lens extending between the upper and lower cover elements, the upper cover element and/or the lower cover element is provided with an housing attachment extension, and/or the lens is provided with a lens attachment extension at least one of its ends.

The at least one reflector may be provided by or on the light guide and/or the supporting element, in particular provided on the housing, especially a supporting element of the housing to which the at least one light guide and/or the at least one light source is detachably mounted.

It is also proposed that the at least one light source is arranged behind a part of the housing, in particular the upper cover element, and/or the reflector, and/or the at least one light source is screened such that it cannot be seen from the outside.

The present disclosure also provides an external rear-view device for motor vehicles, comprising a foot configured to be fixedly secured to the vehicle; a head attached to the foot defining at least one opening for at least one rear-view element and defining at least one recess extending along a portion thereof for at least one lighting device of any one of the preceding claims.

The at least one lighting device may provide a turn-signal lamp.

Embodiments of the external rear view device may be defined in that the head comprises at least two cover elements, in particular the upper cover element and the lower cover element, wherein the outer surface of the lens or a lens part flushes with the outer surface of the head and/or the at least two cover elements.

It may also be that the at least one rear-view element comprises at least one camera, rear-view mirror and/or display.

In addition, the present disclosure provides a motor vehicle comprising at least one external rear view device according to the present disclosure.

The two component mold unit of the lighting device of the present disclosure allows to realize different signature lighting concepts in particular for rear-view devices of motor vehicles. The three dimensional shape allows three dimensional impressions, even with a depth effect.

Due to the provision of the light guide and the mask in a single unit, assembling of the lighting device of the present disclosure is facilitate, which reduces costs.

### BRIEF DESCRIPTION OF THE DRAWINGS

Further features and advantages of the present disclosure are derived from the following description, in which embodiments are explained in the framework of schematic drawings, wherein:

FIG. 1a is a diagram illustrating a perspective view of a rear-view device with a lighting device according to a first embodiment of the present disclosure;

FIG. 1b is a front view of a vehicle according to the present disclosure, with a rear-view device of FIG. 1a;

FIG. 2 is a diagram illustrating a schematic cross-section view of a second embodiment of a lighting device of the present disclosure; and

FIG. 3 is a diagram illustrating a schematic cross-section view of a third embodiment of a lighting device of the present disclosure.

### DETAILED DESCRIPTION

It is to be understood that the embodiments described are merely exemplary of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

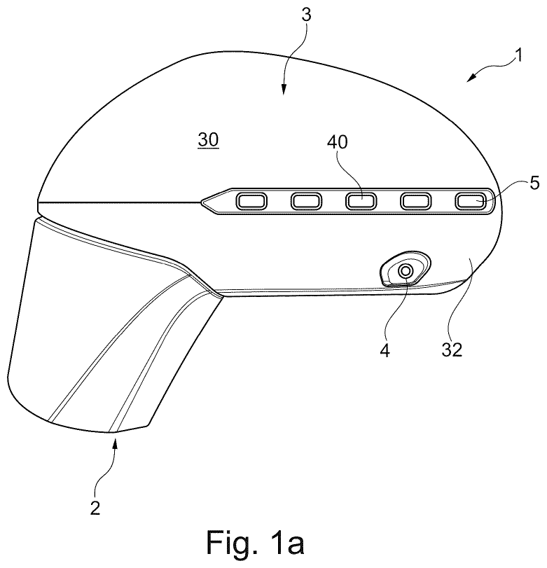

FIG. 1a shows an external rear-view device 1 of the present disclosure. It comprises a foot 2 to be fixedly attached to a vehicle 100 as shown in FIG. 1b. A head 3 is attached to the foot 2 in movable manner. Said head 3 comprises two cover elements 30, 32, between which a lighting device 5 acting as a turn-signal lamp extends. In addition to said turn-signal function, the lighting device 5 can also provide signature lighting associated for example with a manufacturer of the vehicle 100. Such signature lighting may be in form of a specific light pattern 40 having a three-dimensional impression with a depth effect due to the specific structure of the lighting device 5 to enhance the aesthetic appeal.

Before turning to the structure of the lighting device 5, it is to be mentioned, that the rear-view device 1, the front portion of which is shown in FIG. 1a in a perspective view, also carries a camera device 4 extending through the cover element 32; as well as rear-view mirror on its front side, which is not shown.

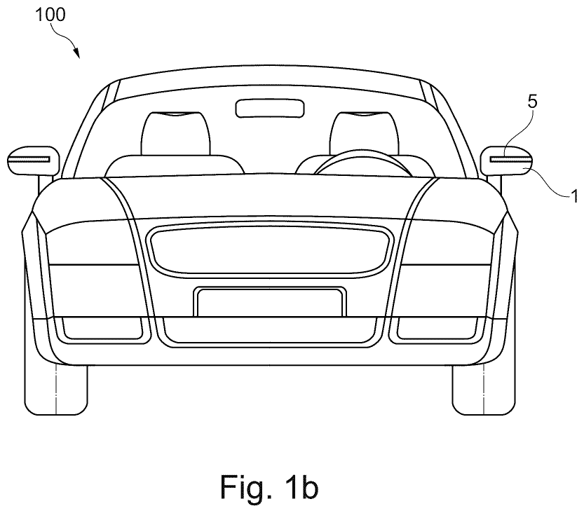

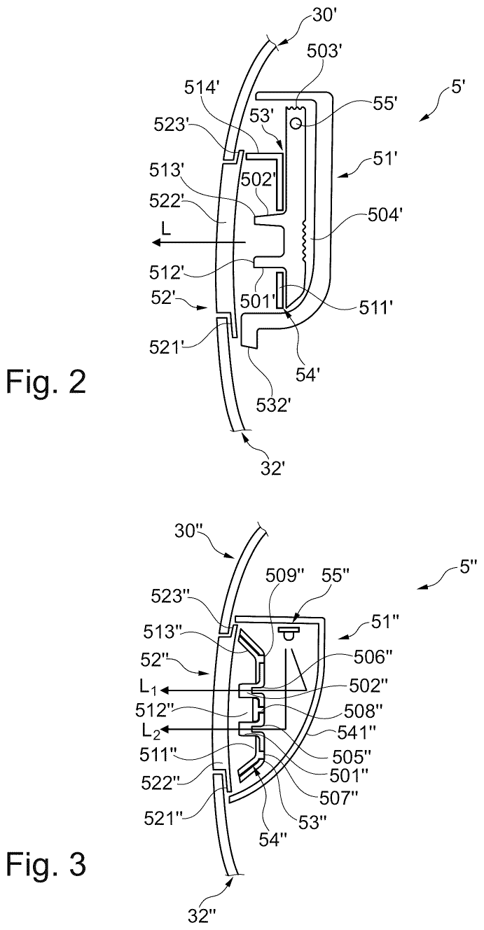

The inner structure of the lighting device 5 is further illustrated with respect to two embodiments shown in FIGS. 2 and 3.

FIG. 2 shows a lighting device 5′ attached between two cover elements 30′, 32′ of a housing, which may be provided by a rear-view device head. Said lighting device 5′ comprises a supporting element 51′ as further part of the housing and a lens 52′ having a main part 522′ flushing with the two cover elements 30′, 32′. Between the lens 52′ and the supporting element 51′ a two component mold unit, comprising a light guide 53′ and a mask 54′, as well as a light source 55′ are arranged such that light emitted from the light source 55′ is guided through the light guide 53′ and exits the same between mask parts 511′ to 514′, see the light beam L in FIG. 2.

The light guide 53′ together with the mask 54′ is formed with a three-dimensional shape; that is with two projections 501′, 502′. Mask parts 511′ and 514′ are provided on both sides of the projections 501′, 502′. On the top of the two projections 501′, 502′, facing the lens 52′, further mask parts 512′ and 513′ may be arranged such that the light beam L can only exit the light guide 53′ between the two projections 501′, 502′. As an alternative (not shown) the top of each projection 501′, 502′, which faces the lens 52′, may determine the preferred light decoupling area. Still further mask parts may be arranged between the two projections.

In order to have a homogeneous light output, specific optics 503′, 504′ may be provided at light in-coupling regions and opposite light out-coupling regions of the light guide 53′, with the optics 504′ reflecting light beams propagating within the light guide 53′ and, thus, acting as a reflector.

The lens 52′ is provided with three regions or parts, with the main part 522′ being arranged between the cover elements 30′ and 32′ such that its outer surface flushes with the outer surfaces of the cover elements 30′, 32′. In addition, two lens parts 521′, 523′ may be extending from the main lens part 522′ in order to extend along the inner surface of the cover elements 30′, 32′, respectively, enabling an attachment.

The supporting element 51′ may be provided with a housing extension 532′, which extends substantially parallel to the lens part 521′ as well as the cover element 32″ in a region of attachment. Still further, the mask 54′ may be provided with an extension part 514′, extending towards the inner surface of the lens 52′, in particular its part 523′, also for facilitating an attachment.

The three-dimensional effect achieved by the two component mold unit 53′, 54′ can lead to a light pattern 40 as shown in FIG. 1.

FIG. 3 shows an alternative lighting device 52″, again arranged between two cover elements 30″ and 32″ of a head of a rear-view mirror, with a lens 52″ corresponding to the lens 52′ discussed with respect to FIG. 2 and thus being provided with lens parts 521″, 522″ and 523″.

In the embodiment shown in FIG. 3, a light source 55″ emits light, which is reflected by a reflector in form of a reflection layer 541″ provided on an inner surface of the supporting element 51′ such that the light enters the two component mold unit 53″, 54″ in the region of two recesses 505″ and 506″ provided within two projections 501′, 502″ of the light guide 53″, with said projections 501″, 502′ not being covered by mask parts. Rather, mask parts 511″, 512″ and 513″ are arranged on the sides of the projections 501″, 502″, even extending through openings 507″, 508″, 509″ within the light guide 53″. This structure leads to bundling of light beams emitted by the light source 55″ such that the light is exiting the two component mold unit in form of two light beams L₁, L₂, as shown in FIG. 3.

The three-dimensional structure of the two component mold unit 53″, 54″ not only allows to obtain specific three-dimensional appearing signature lightings, but also facilitates an attachment by the ends of said unit facing the lens 52″, in particular the ends provided by the lens parts 521″, 523″.

For both embodiments, shown in FIGS. 2 and 3 respectively, the light source 55′, 55″ cannot be seen from the outside through the lens 52″, 52″ due to the mask arrangement.

Thus, the two component mold unit used with the lighting device of the present disclosure can be provided with a three-dimensional shape and a mask on selected areas of a light guide to generate numerous different lighting effects, not only restricted to a two-dimensional appearance but rather allowing three-dimensional effects. This allows new lighting concepts to individualize the appearance of turn-signals of rear-view devices or other components of a motor vehicle, without being restricted thereto.

Further lighting effects can be achieved when making usage of a color changing light source and/or a plurality of light sources associated with a plurality of one or more two-component mold units. Each of said unity might be provided with a plurality of projections in order to provide any kind of pattern, for example in form of a logo, symbol, icon and/or text.

The features represented in the foregoing description, in the claims, and in the figures can be essential for the present disclosure in its different embodiments both individually as well as in any desired combination.

### REFERENCE SIGNS

1 rear-view device
2 foot
3 head
4 camera device
5, 5′, 5″ lighting device
30, 30′, 30″ cover element
32, 32′,32″ cover element
40 light pattern
51′, 51″ supporting element
52′, 52″ lens
53′, 53″ light guide
54′, 54″ mask
55′, 55″ light source
100 vehicle
501′, 501″ projection
502′, 502″ projection
503′ optics
504′ optics
505″ recess
506″ recess
507″ opening
508″ opening
509″ opening
511′, 511″ mask part
512′, 512″ mask part
513′, 513″ mask part
514′ mask part
521′, 521″ lens part
522′, 522″ lens part
523′, 523″ lens part
532′ housing extension
541″ reflection layer
L light beam
L₁ light beam
L₂ light beam

1-13. (canceled)

14. A lighting device, comprising:
at least one housing;
at least one lens;
at least one light source; and
at least one light guide arranged at least partly between the housing and the lens, wherein light emitted by the at least one light source is coupled into the at least one light guide, to be directed to the at least one lens and to exit the at least one lens,
wherein the light guide is formed together with a mask as a two component mould unit in a three dimensional shape adapted to a selected light pattern.

15. The lighting device of claim 14, wherein the light guide formed together with the mask is formed with one or more of:
at least one light guide projection extending towards the at least one lens, tapering in a direction of the lens;
at least one recess, wherein the at least one recess is at least one of (i) within a region of the at last one light guide projection, (ii) on a side facing away from the lens and/or the mask, or (iii) providing at least one light in-coupling regions;
at least one opening, wherein the at least one opening is at least one of (i) between two light guide projection, (ii) on both sides of each light guide projection, or (iii) extending through the light guide; or
optics in at least one light in-coupling region, light reflecting region, and/or light out-coupling region not covered by the mask.

16. The lighting device of claim 15, wherein the mask is formed with one or more of:
at least one first mask part on at last one light guide projection;
at least one second mask part between two light guide projections;
third mask parts on both sides of one or more light guide projections;
at least a fourth mask part in the at last one opening;
at least a fifth mask part having an end facing the lens; or
the mask of the two component mould unit facing the lens and/or extending at least partially parallel to the lens.

17. The lighting device of claim 14, wherein the at least one light source comprises one or more LEDs, comprises at least one color changing light source, cooperates with a color changing element, and/or produces one or more light colors.

18. The lighting device of claim 14, wherein the light emitted by the at least one light source is redirected at least once by the two component mould unit and/or at least one reflector.

19. The lighting device of claim 14, wherein the at least one light source is screened by the mask and/or cannot be seen through the lens.

20. The lighting device of claim 14, wherein the two component mould unit is detachably attached to the at least one of the housing and/or the lens.

21. The lighting device of claim 14, wherein the housing comprises an upper cover element and a lower cover element, with the lens extending between the upper and lower cover elements, the upper cover element and/or the lower cover element provided with a housing attachment extension, and/or the lens provided with a lens attachment extension at at least one end.

22. The lighting device of claim 18, wherein the at least one reflector is provided by or on the light guide and/or the supporting element, provided on a supporting element of the housing to which the at least one light guide and/or the at least one light source is detachably mounted.

23. The lighting device of claim 14, wherein the at least one light source is arranged behind the upper cover element and/or the reflector.

24. The lighting device of claim 14, wherein the at least one light source is screened such that it cannot be seen from the outside.

25. An external rear-view device for a motor vehicle, comprising:
a foot configured to be fixedly secured to the vehicle;
a head attached to the foot, defining at least one opening for at least one rear-view element and defining at least one recess extending along a portion thereof for at least one lighting device of claim 14.

26. The external rear-view device of claim 25, wherein the at least one lighting device provides a turn-signal lamp.

27. The external rear-view device of claim 25, wherein the head comprises at least two cover elements, including an upper cover element and a lower cover element, and wherein the outer surface of the lens or a lens part flushes with the outer surface of the head and/or the at least two cover elements.

28. The external rear-view device of claim 25, wherein the at least one rear-view element comprises at least one camera, rear-view mirror, and/or display.

29. A motor vehicle comprising at least one external rear-view device of claim 25.
